(19) United States
(12) Patent Application Publication
(10) Pub. No.: US 2009/0282014 A1
(43) Pub. Date: Nov. 12, 2009

(54) Systems and Methods for Predicting a Degree of Relevance Between Digital Ads and a Search Query

(75) Inventors: Evgeniy Gabrilovich, Sunnyvale, CA (US); Vassilis Plachouras, Barcelona Catalunya (ES); Andrei Broder, Menlo Park, CA (US); Vanessa Murdock, Barcelona Catalunya (ES); Donald Metzler, Santa Clara, CA (US); Vanja Josifovski, Los Gatos, CA (US); Massimiliano Ciaramita, Barcelona Catalunya (ES); Marcus Fontoura, Bethpage, NY (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/116,710

(22) Filed: May 7, 2008

(51) Int. Cl. G06F 17/30

(52) U.S. Cl. 707/5; 707/E17.108

(57) ABSTRACT

Systems and methods for predicting a degree of relevance between a set of candidate digital ads and a search query are disclosed. Generally, an ad provider receives a digital ad request associated with a search query. The ad provider identifies a set of candidate digital ads that may be served in response to the digital ad request. A relevance module extracts a set of features from the set of candidate digital ads and the search query associated with the digital ad request, and determines a degree of relevance between the set of candidate digital ads and the search query based on a prediction model and the extracted set of features. If the relevance module determines the set of candidate digital ads is relevant to the search query, the ad provider may serve one or more digital ads from the set of candidate digital ads in response to the received digital ad request.

### RELATED APPLICATIONS

The present application is related to U.S. patent application Ser. No. ______ (Attorney Docket No. 12729/449), filed May 7, 2008, and titled “Systems and Methods for Predicting a Degree of Relevance Between Digital Ads and Webpage Content,” and U.S. patent application Ser. No. ______ (Attorney Docket No. 12729/450), filed May 7, 2008, and titled “Systems and Methods for Building a Prediction Model to Predict a Degree of Relevance Between Digital Ads and a Search Query or Webpage Content,” the entirety of each of which is hereby incorporated by reference.

### BACKGROUND

Online advertisement service providers (ad providers), such as Yahoo! Inc., serve digital ads for placement on a webpage based on bid phrases associated with digital ads and keywords within search queries received at an Internet search engine or keywords obtains from the content of a webpage. In some instances, even though a keyword associated with a digital ad is obtained from a search query or webpage content, it may be inappropriate for an ad provider to serve the digital ad associated with the keyword. For example, a webpage may contain a news story regarding illegal drugs found in a suitcase at an airport. While the ad provider may receive the keyword “suitcase” from the content of the webpage, it would be inappropriate for the ad provider to serve digital ads relating to discounts for suitcases. Serving digital ads that are not relevant to a search query or the content of a webpage both frustrates advertisers, whose digital ads are not being displayed to interested potential customers, and Internet users who are viewing digital ads that are not relevant to a submitted search query or a viewed webpage. Accordingly, improved systems and methods for predicting a degree of relevance between digital ads and a search query or webpage content are desirable.

### BRIEF DESCRIPTION OF THE DRAWINGS

FIG. 1 is a block diagram of an environment in which a system for predicting a degree of relevance between digital ads and a search query or webpage content may operate;

FIG. 2 is a block diagram of one embodiment of a system for predicting a degree of relevance between digital ads and a search query or webpage content;

FIG. 3 is a flow chart of one embodiment of a method for creating a model to predict a degree of relevance between digital ads and a search query or webpage content;

FIG. 4 is a flow chart of one embodiment of a method for using a model to predict whether a set of digital ads is relevant to webpage content; and

FIG. 5 is a flow chart of one embodiment of a method for using a model to predict whether a set of digital ads is relevant to a search query.

### DETAILED DESCRIPTION OF THE DRAWINGS

The present disclosure is directed to systems and methods for predicting a degree of relevance between digital ads and a search query or webpage content. Determining a degree of relevance between a digital ad and a search query or webpage content before serving the digital ad allows an ad provider to improve the accuracy of the digital ads it serves. By improving the accuracy of served digital ads, advertiser satisfaction with the ad provider is increased because the digital ads of the advertiser are being displayed to interested customers. Additionally, improving the accuracy of served digital ads increases Internet user satisfaction because the Internet users are being shown advertisements for products or services in which the Internet user may actually be interested.

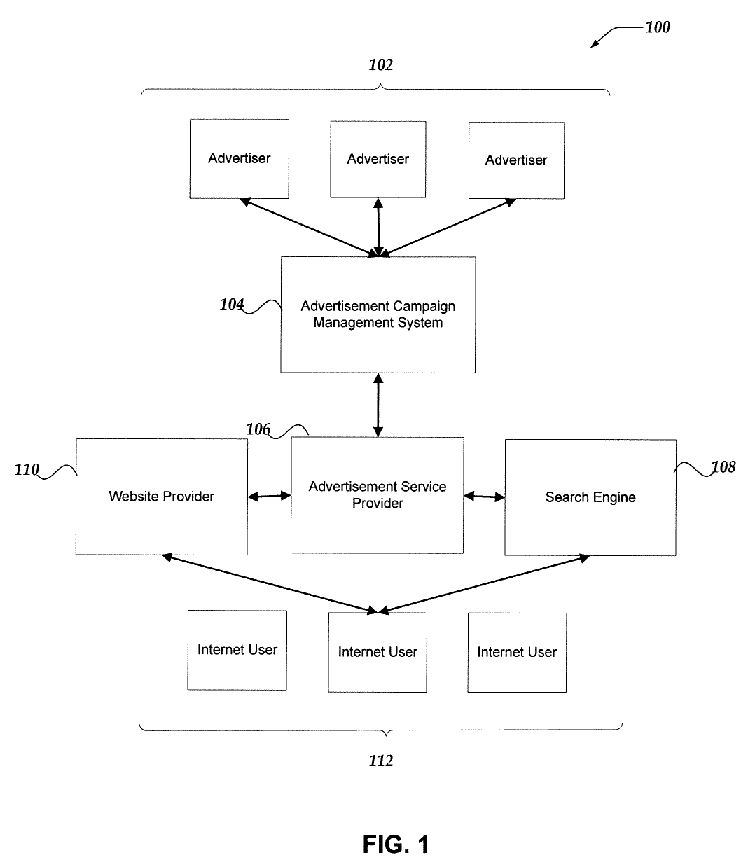

FIG. 1 is a block diagram of an environment in which a system for predicting a degree of relevance between digital ads and a search query or webpage content may operate. The environment 100 may include a plurality of advertisers 102, an ad campaign management system 104, an ad provider 106, a search engine 108, a website provider 110, and a plurality of Internet users 112. Generally, an advertiser 102 bids on terms and creates one or more digital ads by interacting with the ad campaign management system 104 in communication with the ad provider 106. The advertisers 102 may purchase digital ads based on an auction model of buying ad space or a guaranteed delivery model by which an advertiser pays a minimum cost-per-thousand impressions (i.e., CPM) to display the digital ad. Typically, the advertisers 102 may select—and possibly pay additional premiums for—certain targeting options, such as targeting by demographics, geography, behavior (such as past purchase patterns), “social technographics” (degree of participation in an online community) or context (page content, time of day, navigation path, etc.). The digital ad may be a graphical ad that appears on a website viewed by an Internet user 112, a sponsored search listing that is served to an Internet user 112 in response to a search performed at a search engine, a video ad, a graphical banner ad based on a sponsored search listing, and/or any other type of online marketing media known in the art.

When an Internet user 112 performs a search at a search engine 108, the search engine 108 typically receives a search query comprising one or more keywords. In response to the search query, the search engine 108 returns search results including one or more search listings based on keywords within the search query provided by the Internet user 112. Additionally, the ad provider 106 may receive a digital ad request based on the received search query. In response to the digital ad request, the ad provider 106 serves one or more digital ads created using the ad campaign management system 104 to the search engine 108 and/or the Internet user 112 based on keywords within the search query provided by the Internet user 112.

Similarly, when an Internet user 112 requests a webpage served by the website provider 110, the ad provider 106 may receive a digital ad request. The digital ad request may include data such as keywords obtained from the content of the webpage. In response to the digital ad request, the ad provider 106 serves one or more digital ads created using the ad campaign management system 104 to the website provider 110 and/or the Internet user 112 based on the keywords within the digital ad request.

When the digital ads are served, the ad campaign management system 104 and/or the ad provider 106 may record and process information associated with the served digital ads for purposes such as billing, reporting, or ad campaign optimization. For example, the ad campaign management system 104 and/or the ad provider 106 may record the factors that caused the ad provider 106 to select the served digital ads; whether the Internet user 112 clicked on a URL or other link associated with one of the served digital ads; what additional search listings or digital ads were served with each served digital ad; a position on a webpage of a digital ad when the Internet user 112 clicked on a digital ad; and/or whether the Internet user 112 clicked on a different digital ad when a digital ad was served. One example of an ad campaign management system that may perform these types of actions is disclosed in U.S. patent application Ser. No. 11/413,514, filed Apr. 28, 2006, and assigned to Yahoo! Inc., the entirety of which is hereby incorporated by reference.

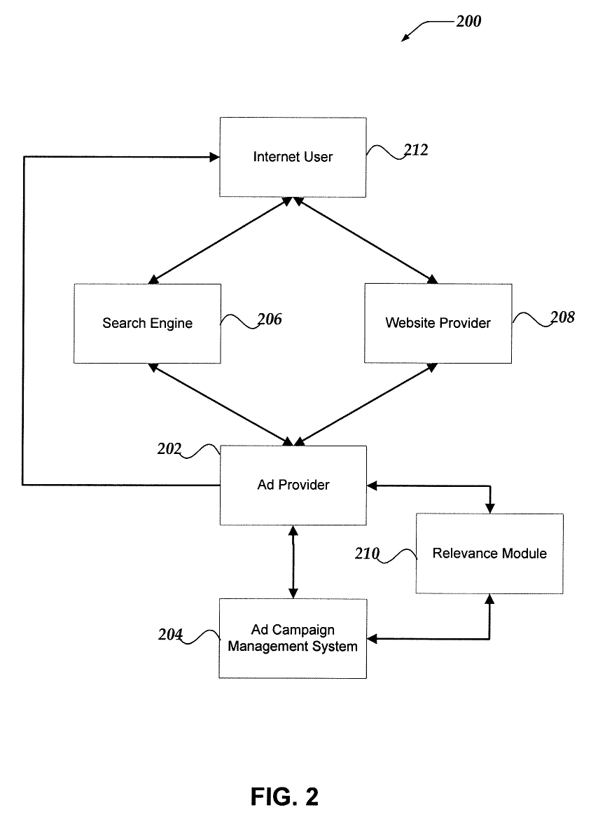

FIG. 2 is a block diagram of a system for predicting a degree of relevance between digital ads and a search query or webpage content. Generally, the system 200 may include an ad provider 202, an ad campaign management system 204, a search engine 206, a website provider 208, and a relevance module 210.

In one implementation, the relevance module 210 may be part of the ad provider 202, ad campaign management system 204, search engine 206, and/or website provider 208. However, in other implementations, the relevance module 210 is distinct from the ad provider 202, ad campaign management system 204, search engine 206, and website provider 208.

The ad provider 202, ad campaign management system 204, search engine 206, website provider 208, and relevance module 210 may communicate with each other over one or more external or internal networks. The networks may include local area networks (LAN), wide area networks (WAN), and/or the Internet, and may be implemented with wireless or wired communication mediums such as wireless fidelity (WiFi), Bluetooth, landlines, satellites, and/or cellular communications. Further, the ad provider 202, ad campaign management system 204, search engine 206, website provider 208, and relevance module 210 may be implemented as software code running in a single server, a plurality of servers, or any other type of computing device known in the art.

Generally, an Internet user 212 may request a webpage from the website provider 208. In response, the website provider 208 sends one or more digital ad requests to the ad provider 202 including keywords from the content of the webpage and/or a location of the webpage, such as a universal resource locator (“URL”). The ad provider 202 identifies a set of candidate digital ads to serve to the Internet user 212 based on keywords within the content of the requested webpage. However, before serving one or more of the candidate digital ads, the relevance module 210 examines the candidate digital ads and the content of the requested webpage, and uses a prediction model to predict a degree of relevance between the candidate digital ads and the content of the requested webpage. If the relevance module 210 determines the candidate digital ads are relevant to the content of the requested webpage, the ad provider 202 serves one or more of the candidate digital ads to the Internet user 212. However, if the relevance module 210 determines the candidate digital ads are not relevant to the content of the requested webpage, the ad provider 202 does not serve any of the candidate digital ads to the Internet user 212.

Alternatively, an Internet user 212 may submit a search query to the search engine 206. In response, the search engine 206 sends one or more digital ad requests to the ad provider 202 including keywords from the search query and/or the actual search query itself. The ad provider 202 identifies a set of candidate digital ads to serve to the Internet user 212 based on keywords within the search query. However, before the ad provider 202 serves one or more of the candidate digital ads, the relevance module 210 examines the candidate digital ads and the received search query, and uses a prediction model to predict a degree of relevance between the candidate digital ads and the received search query. If the relevance module 210 determines the candidate digital ads are relevant to the received search query, the ad provider 202 serves one or more of the candidate digital ads to the Internet user 212. However, if the relevance module 210 determines the candidate digital ads are not relevant to the received search query, the ad provider 202 does not serve any of the candidate digital ads to the Internet user 212.

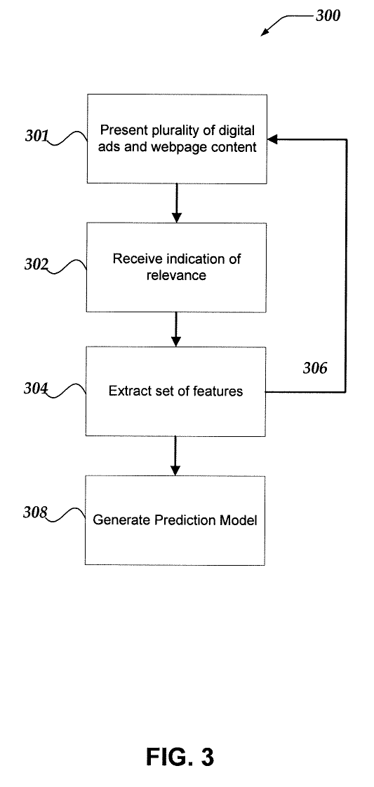

FIG. 3 is a flow chart of one embodiment of a method for generating a model to predict a degree of relevance between digital ads and a search query or webpage content. While the method below is described with respect to generating a model to predict a degree of relevance between digital ads and webpage content, it will be appreciated that the same method may be employed to generate a model to predict a degree of relevance between digital ads and a search query.

The method 300 begins with an ad campaign management system and/or a relevance module constructing a training set by presenting a plurality of digital ads and webpage content to a human operator at step 301 and receiving an indication from the human operator at step 302 of whether the presented plurality of digital ads is relevant to the presented webpage content. In some implementations the human operator may indicate that the plurality of digital ads is relevant to a webpage or is not relevant to the webpage. However, in other implementations the human operator may indicate a degree of relevance between the plurality of digital ads and the content of the webpage on a scale, such as zero to ten.

In other implementations, rather than presenting a human operator with a plurality of digital ads and webpage content at step 301 and receiving an indication of relevance at step 302, an ad campaign management system and/or a relevance module may implicitly determine a degree of relevance between the plurality of digital ads and the content of the webpage by based on click-through information available in sources such as search logs. For example, if Internet users typically click on a digital ad when displayed on a given webpage, the ad campaign management system and/or relevance module may infer that the digital ad is relevant to the webpage content. Additionally, based on factors such as a click-through rate of the digital ad with respect to the given webpage, the ad campaign management system and/or relevance module may be able to determine a degree of relevance between the digital ad and the content of the webpage.

At step 304, the relevance module extracts a set of features from the plurality of digital ads and the content of the webpage. A feature typically measures a degree of relevance between the plurality of digital ads and webpage content, measures an overall quality of the plurality of digital ads, or measures a relationship between the digital ads of the plurality of digital ads themselves. In one implementation, the set of features may include information regarding a digital ad and/or webpage content with respect to word overlap, cosine similarity, translation, pointwise mutual information, chi-squared, bid price, score coefficient of variation, and topical cohesiveness, each of which is described below.

Word overlap is a feature that measures a degree to which terms, also known as keywords or bid phrases, associated with the plurality of digital ads overlap with terms in the content of the webpage. For each digital ad of the plurality of digital ads, the relevance module may create a word overlap score based on whether all the terms associated with the digital ad are present in the content of the webpage, whether none of the terms associated with the digital ad are present in the content of the webpage, or a proportion of the terms associated with the digital ad that are present in the content of the webpage. The word overlap score of each digital ad is then aggregated to calculate a word overlap score of the plurality of digital ads and the content of the webpage.

In some implementations, for a feature X measuring a degree of relevance between digital ads and webpage content such as the word overlap feature, the relevance module may calculate four values associated with the feature using the equations:

$$\begin{matrix}{X}_{min} ( P , A ) = {min}_{A ∈ A} X ( P , A ) \\ {X}_{max} ( P , A ) = {max}_{A ∈ A} X ( P , A ) \\ {X}_{mean} ( P , A ) = {\sum }_{A ∈ A} \frac{X ( P , A )}{\vert A \vert} \\ {X}_{w mean} ( P , A ) = {\sum }_{A ∈ A} \frac{SCORE ( P , A ) \cdot X ( P , A )}{{\sum }_{{A}^{′} ∈ A} SCORE ( Q , {A}^{′} )}\end{matrix}$$

where A is the plurality of digital ads, P is the webpage, and SCORE(P,A) is an ad score returned by an ad provider for a digital ad with respect to terms from the webpage. An ad score is typically a measure of the degree of relevance between a digital ad and a keyword.

Xₘᵢₙ(P,A) results in a minimum feature value associated with a digital ad of the plurality of digital ads and webpage content. For example, a plurality of digital ads may include a first digital ad, a second digital ad, a third digital ad, a fourth digital ad, and a fifth digital ad. The first digital ad is associated with a word overlap score of 1, the second digital ad is associated with a word overlap score of 2 the third digital ad is associated with a word overlap score of 3, the fourth digital ad is associated with a word overlap score of 4, and the fifth digital ad is associated with a word overlap score of 5. Accordingly, the Xₘᵢₙ(P,A) of the word overlap feature for the plurality of digital ads is 1 because 1 is the lowest word overlap score associated with one of the digital ads of the plurality of digital ads.

Xₘₐₓ(P,A) results in a maximum feature value associated with a digital ad of the plurality of digital ads and webpage content. Continuing with the example above, the Xₘₐₓ(P,A) of the word overlap feature of the plurality of digital ads is 5 because 5 is the greatest word overlap score associated with one of the digital ads of the plurality of digital ads.

Xₘₑₐₙ(P,A) results in a mean of the feature values associated with the digital ads of the plurality of digital ads and webpage content. Continuing with the example above, Xₘₑₐₙ(P,A) of the word overlap feature is 3 because 3 is the average of the word overlap scores associated with the digital ads of the plurality of digital ads.

X_{wmean}(P,A) results in a mean of the feature values associated with the digital ads of the plurality of digital ads and webpage content that has been weighted based on an ad score associated with each digital ad of the plurality of digital ads. Continuing with the example above, if the first digital ad is associated with an ad score of 1, the second digital ad is associated with an ad score of 2, the third digital ad is associated with an ad score of 3, the fourth digital ad is associated with an ad score of 4, and the fifth digital ad is associated with an ad score of 5, X_{wmean}(P,A) of the word overlap feature is calculated to be 3.67.

Cosine similarity is a feature that measures a degree to which terms associated with the plurality of digital ads overlap with terms in the content of the webpage, with a score that has been weighted based on a number of times a term appears in both the plurality of digital ads and the content of the webpage. In one implementation, the cosine similarity feature may be calculated using the equation:

$$sim ( P , A ) = \frac{{\sum }_{t ∈ P ⋂ A} {w}_{Pt} {w}_{At}}{\sqrt{{\sum }_{t ∈ P} {w}_{Pt}^{2}} \sqrt{{\sum }_{t ∈ A} {w}_{A t}^{2}}}$$

where w_{Pt} (weight with respect to webpage and term) and w_{At} (weight with respect to digital ad and term) are the term frequency-inverse document frequency (tf.idf) weights of the term t in the webpage and digital ad, respectively. The tf.idf weighs of terms result in terms that appear a significant number of times in the plurality of digital ads and/or the webpage content being given a large weight, and terms that rarely appear in the plurality of digital ads and/or the webpage content also being given a large weight. For a further discussion of tf.idf weights, see G. Salton and M McGill, An Introduction to Modern Information Retrieval, McGraw-Hill, 1983, ISBN 0070544840.

The tf.idf weight w_{Pt} of term t in the webpage may be computed using the equation:

$${w}_{Pt} = tf \cdot {log}_{2} ( \frac{N + 1}{{n}_{t} + 0.5} )$$

where tf is term frequency, N is the total number of digital ads in the plurality of digital ads, and nₜ is the number of digital ads in the plurality of digital ads in which term t occurs. The weight w_{At} of term t in the plurality of digital ads may be computed in the same way.

Translation is a feature that measures a degree of topical relationship between the plurality of digital ads and the content of the webpage. As explained in more detail below, to calculate a translation score, the relevance module generally computes a probability that two terms (in the same language) are associated with each other, such that one term appears in the plurality of digital ads and the other term appears in the webpage content.

The translation feature indicates a degree of topical relationship between a plurality of digital ads and webpage content even though the same term does not appear in both the plurality of digital ads and the content of the webpage, as required by features such as word overlap and cosine similarity. For example, if the plurality of digital ads includes the term “old cars” and the content of the webpage includes the term “antique automobiles,” the translation feature would indicate that the plurality of digital ads and the content of the webpage are related due to the relationship between the terms “old cars” and “antique automobiles.”

It will be appreciated that when a digital ad is translated into terms to be matched with terms from the webpage content, some information regarding the full meaning of the digital ad is lost. To capture the difference between terms and a full digital ad, the relevance module may build translation tables such as those described in Y. Al-Onaizan, J. Curin, M. Jahr, K. Knight, J. Lafferty, D. Melamed, F. J. Och, D. Purdy, N. A. Smith, and D. Yarowsky, Statistical Machine Translation, Final Report, JHU workshop, 1999; P. F. Brown, J. Cocke, S. A. Della Pietra, V. J. Della Pietra, F. Jelineck, J. D. Lafferty, R. L. Mercer, and P. S. Roossin, A Statistical Approach to Machine Translation, Computational Linguistics, 16(2):79-85, 1990; and P. F. Brown, S. A. Della Pietra, V. J. Della Pietra, and R. L. Mercer, The Mathematics of Statistical Machine Translation: Parameter Estimation, Computational Linguistics 19(2):263-311, 1993.

The translation tables provide a distribution of a probability of a first term translating to a second term, given an alignment between two sentences, and other information such as how likely a term is to have many other translations, the relative distance between two terms in their respective sentences, and the appearance of words in common classes of words.

As stated above, to calculate a translation score, the relevance module may compute a probability that two terms (in the same language) are associated with each other, such that one term appears in the plurality of digital ads and the other term appears in the webpage content. To compute the probability, the relevance module concatenates the plurality of digital ads to form a meta-document, also known as a “source.” The relevance module also concatenates the webpage content to form a second meta-document, also known as a “target.” The “source” and “target” are known collectively as a “parallel corpus.”

The relevance module determines a number of times a term in the source is associated with a term in the target, and normalizes the total number of times the term was found in the source. The relevance module then computes an alignment between the source and the target by assuming that a pair of terms with a highest probability are aligned with each other, and then aligning the remaining terms in each of the source and target sentence pairs accordingly. It should be appreciated that each term in the source may be aligned with one term in the target, but that each term in the target may be aligned with any number of terms in the source, because the relevance module iterates over source terms and looks at each term one time.

The relevance module then re-estimates a number of times a source term is associated with a target term, given the alignment described above. The above-described steps of estimating probabilities, adjusting the alignment to maximize the probabilities, and re-estimating the probabilities are repeated until the probabilities do not change, or change only a very small amount.

In some implementations, the relevance module may improve the alignment by limiting a number of words a term in the target is allowed to translate to; by preventing words at the beginning of the source sentence from translating to words at the ends of the target sentence; and/or by grouping words together that are similar in meaning or semantic context and aligning words that appear in the same group.

The relevance module may calculate a translation score of the plurality of digital ads and the content of the webpage based on factors such as an average of the translation properties of all terms in the content of the webpage translating to all terms in a title and description of a candidate digital ad, or a proportion of terms in the content of a webpage that have a translation in a title or description of a digital ad.

Pointwise mutual information and chi-squared are features that measure a degree of relevance between the plurality of digital ads and the content of the webpage based on a co-occurrence of terms. For example, if a digital ad includes both the term automobile and the term car, and the content of a webpage includes both the term automobile and the term car, because the terms automobile and car are related and appear in both the digital ad and the webpage content, pointwise mutual information and chi-squared information will indicate that the digital ad and the webpage content are related.

In one implementation, pointwise mutual information may be calculated using the equation:

$$PMI ( {t}_{1} , {t}_{2} ) = {log}_{2} \frac{P ( {t}_{1} , {t}_{2} )}{P ( {t}_{1} ) P ( {t}_{2} )}$$

where t₁ is a term from the webpage content, t₂ is a term from a digital ad, P(t) is a probability that term t appears anywhere on the Internet, and P(t₁,t₂) is a probability that terms t₁ and t₂ occur in the same webpage. In some implementations P(t) may be calculated by dividing the number of webpages that occur on the Internet where term t is present divided by the total number of webpages that occur on the Internet. Similarly, P(t₁,t₂) may be calculated by dividing the number of webpages that occur on the Internet where terms t₁ and t₂ are present divided by the total number of webpage that occur on the Internet. It will be appreciated that a number of webpages that occur on the Internet may be approximated based on a number of webpages indexed by a commercial search engine.

In some implementations, the relevance module forms pairs of terms t₁ and t₂ for the pointwise mutual information calculation by extracting a top number of terms, such as the top 50 terms, based on the tf.idf weight of the terms in a webpage.

In one implementation, chi-squared may be calculated using the equation:

$${X}^{2} = \frac{\vert L \vert {( {o}_{11} {o}_{22} - {o}_{12} {o}_{21} )}^{2}}{( {o}_{11} + {o}_{12} ) ( {o}_{11} + {o}_{21} ) ( {o}_{12} + {o}_{22} ) ( {o}_{21} + {o}_{22} )}$$

where |L| is a number of documents available on the Internet (which may be approximated based on a number of webpages indexed by a commercial search engine) and oᵢⱼ are defined in Table 1.

TABLE 1

| | t₁ | [symbol] t₁ |
|---|---|---|
| t₂ | o₁₁ | o₁₂ |
| [symbol] t₂ | o₂₁ | o₂₂ |

For example, o₁₁ stands for the number of webpages available on the Internet that contain both terms t₁ and t₂, and o₁₂ stands for the number of webpages on the Internet in which t₂ occurs but t₁ does not occur. When a relevance module calculates pointwise mutual information with respect to search queries rather than webpage content, |L| is a number of search queries appearing in one or more search logs, o₁₁ stands for the number of search queries in the search logs that contain both terms t₁ and t₂, and o₁₂ stands for the number of search queries in the search logs in which t₂ occurs but t₁ does not occur. For a further discussion on a chi-squared statistical property, see Greenwood, P. E., Nikulin, M. S., A Guide to Chi-Squared Testing, Wiley, New York, 1996, ISBN 047155779X.

The relevance module computes the chi-squared statistic (X²) for each digital ad and the webpage content, and counts the number of pairs of terms for which the chi-squared statistic is above a threshold, such as 95%. It will be appreciated that if the chi-squared statistic for a pair of terms is above the threshold, the pair of terms is related. Therefore, the more pairs of terms between the plurality of digital ads and the webpage content that are related, the more likely it is that the plurality of digital ads and the webpage content are related.

While the features described above such as word overlap, cosine similarity, translation, pointwise mutual information, and chi-squared measure a degree of relevance between the plurality of digital ads and webpage content, it will be appreciated that the features described below such as bid price, coefficient of variation, and topical cohesiveness measure how related the digital ads of the plurality of digital ads are to each other.

Bid price is a feature that may indicate an overall quality of a plurality of digital ads. For example, if the digital ads of the plurality of digital ads are associated with a large bid price for a term obtained from the content of the webpage, the fact that an advertiser is willing to pay a large amount for an action associated with their digital ad is likely an indication that a digital ad is of a high quality. Therefore, the plurality of digital ads is likely of a high overall quality.

Conversely, if a number of digital ads of the plurality of digital ads are associated with a small bid price for a term obtained from the content of the webpage, the fact that an advertiser is only willing to pay a small amount for an action associated with their digital ad is likely an indication that a digital ad is of a low quality. Therefore, the plurality of digital ads is likely of a low overall quality.

Coefficient of variation is a feature that measures a degree of variance of ad scores between the digital ads of the plurality of digital ads. As described above, an ad score is a value that represents a degree of relevance between a digital ad and a keyword. The relevance module typically uses coefficient of variation information instead of a standard deviation or variance information because coefficient of variation information is normalized with respect to a mean of the ad score.

In one implementation, the relevance module may calculate a coefficient of variation using the equation:

$$COV = \frac{{σ}_{SOURCE}}{{μ}_{SCORE}}$$

where σ_{SCORE} is a standard deviation of the ad scores of the digital ads in the plurality of digital ads and μ_{SCORE} is a mean of the ad scores of the digital ads in the plurality of digital ads.

Topical cohesiveness is a feature that measures how topically related the digital ads of the plurality of digital ads are to each other. For example, if a term “cheap hotels” is obtained from the content of a webpage and the bid phrases associated with the plurality of digital ads are “cheap cars,” “hotel discounts,” and “swimming pools,” then the plurality of digital ads have a low topical cohesiveness since they relate to very different topics. However, if the term “cheap hotels” is obtained from the content of the webpage and the bid phrases associated with the plurality of digital ads are “hotel discounts,” “inexpensive hotels,” and “vacation hotels,” then the results are more topically cohesive and more likely to be satisfying to an Internet user.

Typically, if a plurality of digital ads is of a high quality, the digital ads of the plurality of digital ads will also be topically related. Conversely, if the plurality of digital ads is of a low quality, the digital ads of the plurality of digital ads are typically not topically related. However, it should be appreciated that because a plurality of digital ads may be topically related to each other, but not related to the content of a webpage or a search query, the topical cohesive feature is typically used in conjunction with other features, such as the word overlap, cosine similarity, pointwise mutual information, and chi-squared features described above, to determine a degree of relevance between digital ads and the content of a webpage or a search query.

To measure a topical cohesiveness of the plurality of digital ads, the relevance module may build a relevance model over terms and/or semantic classes. With respect to terms, the relevance module may first build a statistical model using the equation:

$${θ}_{w} = {\sum }_{A ∈ A} P ( w \vert A ) P ( A \vert WP )$$

where P(w|A) is a likelihood that term w is present in a digital ad, as explained below; P(A|WP) is a likelihood of a digital ad given the webpage (WP), as explained below; and θ_{w} is shorthand for P(w|WP), which is a multinomial distribution over items w.

The likelihood that a term is present in a digital ad, P(w|A), may be estimated using the equation:

$$P ( w \vert A ) = \frac{{tf}_{w , A}}{\vert A \vert}$$

where tf_{w,A} is a total number of times a term w occurs in a digital ad (A) and |A| is a total number of terms in the digital ad.

The likelihood of a digital ad given a webpage, P(A|WP), may be estimated using the equation:

$$P ( A \vert WP ) = \frac{SCORE ( WP , A )}{{\sum }_{{A}^{′} ∈ A} SCORE ( WP \vert {A}^{′} )}$$

where SCORE(WP,A) is an ad score for a digital ad given a webpage. When θ_{w} is estimated using the equations described above, it is often referred to in information retrieval literature as a relevance model.

With respect to semantic classes, for each digital ad, the relevance module may generate a number of semantic classes associated with the digital ad and a score associated with the digital ad and the semantic class. As known in the art, a semantic class is a topical classification that a digital ad may relate to. Examples of semantic classes include topics such as entertainment, automobile, and sports. Further, each semantic class may include subclasses, such as golf or tennis for the semantic class sports. It will be appreciated that this hierarchy may continue such that each subclass includes further subclasses.

To calculate a relevance model based on semantic classes, the relevance module may estimate P(c|A) using the equation:

$$P ( c \vert A ) = \frac{SCORE ( c , A )}{{\sum }_{c ∈ C} SCORE ( c , A )}$$

where C is a set of semantic classes and SCORE(c,A) is a score assigned by a classifier to semantic class c for digital ad A. The resulting relevance model, θ_{c}, is a multinomial distribution of the semantic classes.

After building a relevance model over terms or classes as described above, the relevance module may measure the cohesiveness of the relevance module. For example, the relevance module may calculate a clarity score measuring a KL-divergence between the relevance model and a collection model. For a further discussion on a clarity score, please see Steve Cronen-Townsent, Yun Zhou, and W. Bruce Croft, Predicting Query Performance, Proceedings of the 25^{th} Annual International ACM SIGIR Conference on Research and Development in Information Retrieval, 299-306, 2002.

The clarity score measures how “far” the relevance model estimated from the plurality of digital ads (θ) is from the model of an entire set of digital ads (\hat{θ}) available at the ad provider, also known as an ad inventory. If the plurality of digital ads is found to be cohesive and focused on one or two topics, the relevance model will be very different from the collection model. However, if the set of topics represented by the plurality of digital ads is scattered and non-cohesive, the relevance model will be very similar to the collection model.

In one implementation, the clarity score may be calculated using the equation:

$$CLARITY ( θ ) = {\sum }_{w ∈ V} {θ}_{w} log \frac{{θ}_{w}}{{\hat{θ}}_{w}}$$

where \hat{θ} is the collection model, which is a maximum likelihood estimate computed over the entire collection of digital ads available at an ad provider, θ_{w} is the relevance model, and V is either the set of terms (for term relevance models) or the set of semantic classes (for semantic class relevance models).

The relevance model may additionally be used to calculate an entropy score. Entropy measures how “spread out” a probability distribution is. If a distribution has high entropy, then the distribution is very spread out. Conversely, if the distribution has low entropy, then the distribution is highly peaked and less spread out. By measuring the entropy of either the term relevance model or the semantic class relevance model, the entropy score measures how spread out the terms or semantic classes are with respect to the digital ads. If the entropy is high, then the term or semantic class distribution is very spread out, meaning that the digital ads are not very cohesive. However, if the entropy is low, then the term or semantic class distribution is very peaked and less spread out, meaning that the digital ads are more cohesive.

For example, if a term relevance model is built over five digital ads, where each digital ad includes the term “cars,” then the entropy of the relevance model would be 0, since the relevance model would be peaked around the term “cars” since P(cars|model)=1 and P(other words|model)=0. However, of the five digital ads, if a first digital ad includes the term “cat,” a second digital ad includes the term “dog,” a third digital ad includes the term “rabbit,” a fourth digital ad includes the term “turtle,” and a fifth digital ad includes the term “fish,” then the entropy of the relevance model would be very large, since the distribution is spread across five different terms, instead of just one.

In one implementation, the relevance module may calculate an entropy score using the equation:

$$H ( θ ) = - {\sum }_{w ∈ V} {θ}_{w} log {θ}_{w}$$

It will be appreciated that the calculation of an entropy score does not require the calculation of a background model as described above with respect to the clarity score.

In some implementations, the relevance module computes both clarity and entropy scores based on relevance models estimated from terms in an ad title, an ad description, and ad semantic classes, resulting in a total of six topical cohesiveness scores.

After extracting the set of features from the plurality of digital ads and the content of the webpage at step 304, the method loops (branch 306) to step 301 and the above-described process is repeated for another plurality of digital ads and another webpage. This process is repeated until at step 308 the relevance module generates a prediction model to predict whether a set of candidate digital ads is relevant to the content of a webpage based on the indications of relevance received from one or more human operators received at step 303 and the set of features extracted at step 304. In one implementation, the relevance module generates the prediction model using machine-learning algorithms.

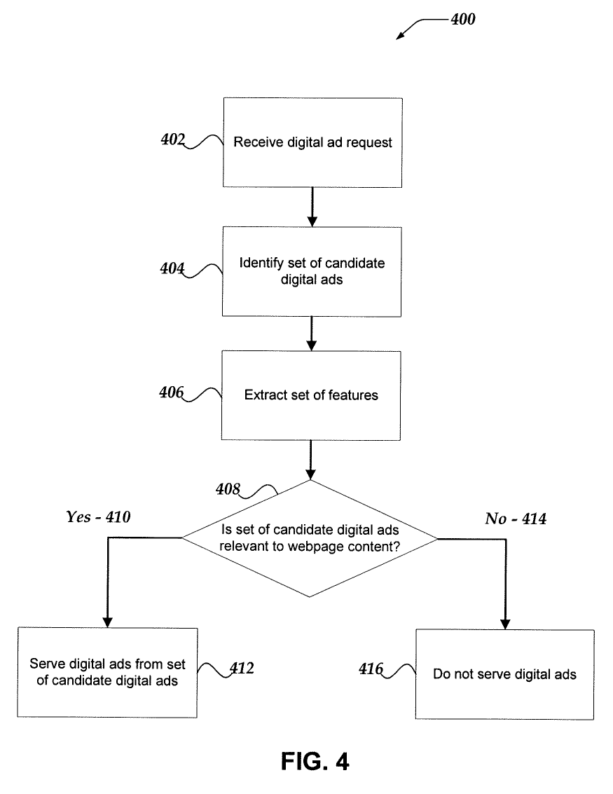

FIG. 4 is a flowchart of one embodiment of a method for predicting whether a set of candidate digital ads is relevant to the content of a webpage. The method 400 begins at step 402 with an ad provider receiving a digital ad request for a digital ad from a website provider. Typically, the digital ad request will include one or more keywords from the content of a webpage and/or a location of the webpage, such as a URL.

At step 404, the ad provider identifies a set of candidate digital ads that may be served to the website provider or an Internet user in response to the digital ad request based on keywords obtained from the content of the webpage. At step 406, a relevance module extracts a set of features, such as those described above, from the set of candidate digital ads and the content of the webpage associated with the digital ad request. At step 408, the relevance module uses a prediction module, such as the predication model created using the method of FIG. 3, to predict whether the set of candidate digital ads identified at step 404 is relevant to the content of the webpage based on the set of features extracted at step 406. In some implementations, the relevance module compares a score resulting from the prediction module against a threshold to determine whether the set of candidate digital ads is relevant to the content of the webpage. In other implementations, the relevance module will result in an actual binary determination of whether the set of candidate digital ads is relevant to the content of the webpage.

If the relevance module determines the set of candidate digital ads is relevant to the content of the webpage (branch 410), the ad provider serves one or more digital ads of the set of candidate digital ads to the website provider and/or an Internet user at step 412 for display on the webpage associated with the digital ad request. However, if the relevance module determines the set of candidate digital ads is not relevant to the content of the webpage (branch 414), the ad provider does not serve digital ads to the website provider in response to the digital ad request at step 416.

In other implementations, when the relevance module determines the set of candidate digital ads is not relevant to the content of the webpage (branch 414), the ad provider may perform other actions at step 416 such as serving one or more digital ads of the set of candidate digital ads, but charging the advertiser a reduced amount for actions associated with the served digital ads; serving one or more non-contextual digital ads, such as a graphical banner ad that is placed on a webpage to increase product awareness or advertise for an upcoming event that is not directly related to the content of the webpage; and/or serving one or more digital ads of the set of candidate digital ads in an order other than the order of their original retrieval by an information retrieval module.

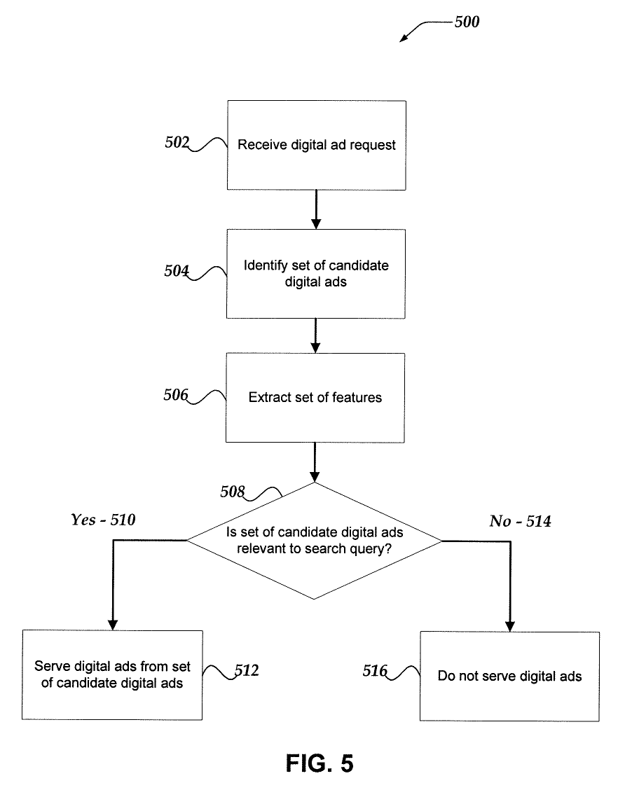

FIG. 5 is a flowchart of one embodiment of a method for predicting whether a set of candidate digital ads is relevant to a search query. The method 500 begins at step 502 with an ad provider receiving a digital ad request from a search engine. Typically, the digital ad request will include one or more keywords from a search query submitted to the search engine and/or the actual search query.

At step 504, the ad provider identifies a set of candidate digital ads that may be served to the search engine and/or an Internet user in response to the digital ad request based on keywords obtained from the search query. At step 506, a relevance module extracts a set of features from the set of candidate digital ads and the search query received at the search engine. At step 508, the relevance module uses a prediction module, such as the prediction model created using the method of FIG. 3, to predict whether the set of candidate digital ads identified at step 504 is relevant to the search query based on the set of features extracted at step 506.

If the relevance module determines the set of candidate digital ads is relevant to the search query (branch 510), the ad provider serves one or more digital ads from the set of candidate digital ads to the search engine and/or the Internet user at step 512 for display in the search results generated by the search engine in response to the search query. However, if the relevance module determines the set of candidate digital ads is not relevant to the search query (branch 514), the ad provider does not serve digital ads to the search engine in response to the digital ad request at step 516.

In other implementations, when the relevance module determines the set of candidate digital ads is not relevant to the search query (branch 514), the ad provider may perform other actions at step 516 such as serving one or more digital ads for the set of candidate digital ads, but charging the advertiser a reduced amount for actions associated with the served digital ads, or serving one or more non-contextual digital ads, such as a graphical banner ad.

While the methods of FIGS. 4 and 5 have been described with a relevance module extracting features from all digital ads of the set of candidate digital ads, in some implementations the relevance module may extract features from only a subset of digital ads from the set of candidate digital ads. For example, the relevance module may extract features from five digital ads of the set of candidate digital ads having the highest ad scores as determined by the ad provider.

Additionally, in some implementations, the relevance module may extract information from a different number of digital ads for each feature. For example, for one set of candidate digital ads, the relevance module may extract information from five digital ads of the set of candidate digital ads for the word overlap feature and extract information from ten digital ads of the set of candidate digital ads for the pointwise mutual information feature.

FIGS. 1-5 disclose systems and methods for predicting a degree of relevance between a set of digital ads and a search query or webpage content. By using a relevance model to predict a degree of relevance between a set of candidate digital ads and a search query or webpage content before serving digital ads, an ad provider is able to more accurately serve relevant digital ads.

It is intended that the foregoing detailed description be regarded as illustrative rather than limiting, and that it be understood that it is the following claims, including all equivalents, that are intended to define the spirit and scope of this invention.

1. A method for predicting a degree of relevance between a set of candidate digital ads and a search query, the method comprising:
receiving a digital ad request associated with a first search query;
identifying a set of candidate digital ads comprising at least one digital ad that may be served in response to the digital ad request;
extracting a set of features from the set of candidate digital ads and the first search query; and
determining a degree of relevance between the set of candidate digital ads and the first search query based on a prediction model and the set of features extracted from the set of candidate digital ads and the first search query.

2. The method of claim 1, further comprising:
receiving an indication of a degree of relevance between a plurality of digital ads and a second search query from a user;
extracting a set of features from the plurality of digital ads and the second search query; and
building the prediction model to predict a degree of relevance between a set of candidate digital ads and a search query based on at least the received indication of relevance and the set of features extracted from the plurality of digital ads and the second search query.

3. The method of claim 1, further comprising:
serving at least one digital ad of the set of candidate digital ads upon a determination that the determined degree of relevance between the set of candidate digital ads and the first search query exceeds a threshold.

4. The method of claim 2, further comprising:
determining not to serve digital ads of the set of candidate digital ads upon a determination that the determined degree of relevance between the set of candidate digital ads and the first search query does not exceed a threshold.

5. The method of claim 1, wherein extracting the set of features from the set of candidate digital ads and the first search query comprises:
determining a degree to which terms associated with the set of candidate digital ads overlap with terms in the first search query.

6. The method of claim 1, wherein extracting the set of features from the set of candidate digital ads and first search query comprises:
determining a degree to which terms associated with the set of candidate digital ads overlap with terms in the first search query, weighted based on a number of times a term appears in both the set of candidate digital ads and the first search query.

7. The method of claim 1, wherein extracting the set of features from the set of candidate digital ads and the first search query comprises:
determining a degree of relevance between the set of candidate digital ads and the first search query based on the co-occurrence of a first term and a second term, which is different from the first term but is related to the first term, in the set of candidate digital ads and the first search query.

8. The method of claim 1, wherein extracting the set of features from the set of candidate digital ads and the first search query comprises:
determining a quality of the set of candidate digital ads based on a bid price associated with two or more digital ads of the set of candidate digital ads.

9. The method of claim 1, wherein extracting the set of features from the set of candidate digital ads and the first search query comprises:
determining a quality of the set of candidate digital ads based on a coefficient of variation of an ad score associated with two or more digital ads of the set of candidate digital ads.

10. The method of claim 1, wherein extracting the set of features from the set of candidate digital ads and the first search query comprises:
determining a quality of the set of candidate digital ads based on a degree of topical cohesiveness of two or more digital ads of the set of candidate digital ads.

11. The method of claim 10, wherein determining a quality of the set of candidate digital ads based on a degree of topical cohesiveness of two or more digital ads of the set of candidate digital ads comprises:
building a relevance model over at least one of terms or semantic classes associated with two or more digital ads of the set of candidate digital ads; and
determining a clarity score for the set of candidate digital ads based on a difference between the relevance model and a model of an ad inventory of an ad provider.

12. The method of claim 10, wherein determining a quality of the set of candidate digital ads based on a degree of topical cohesiveness of two or more digital ads of the set of candidate digital ads comprises:
building a relevance model over at least one of terms or semantic classes associated with two or more digital ads of the set of candidate digital ads; and
determining an entropy score for the set of candidate digital ads based on a probability distribution of the terms or semantic classes over which the relevance model was built.

13. A computer-readable storage medium comprising a set of instructions for predicting a degree of relevance between a set of candidate digital ads and a search query, the set of instructions to direct a processor to perform acts of:
receiving a digital ad request associated with a first search query;
identifying a set of candidate digital ads comprising at least one digital ad that may be served in response to the digital ad request;
extracting a set of features from the set of candidate digital ads and the first search query;
determining a degree of relevance between the set of candidate digital ads and the first search query based on a prediction model and the set of features extracted from the set of candidate digital ads and the first search query; and
determining whether to serve at least one digital ad of the set of candidate digital ads based on the determined degree of relevance between the set of candidate digital ads and the first search query.

14. The computer-readable storage medium of claim 13, further comprising a set of instructions to direct a processor to perform acts of:
receiving an indication of a degree of relevance between a plurality of digital ads and a second search query from a user;
extracting a set of features from the plurality of digital ads and the second search query; and
building the prediction model to predict a degree of relevance between a set of candidate digital ads and a search query based on at least the received indication of relevance and the set of features extracted from the plurality of digital ads and the second search query.

15. The computer-readable storage medium of claim 13, wherein extracting the set of features from the set of candidate digital ads and the first search query comprises at least one of:
determining a degree to which terms associated with the set of candidate digital ads overlap with terms in the first search query;
determining a degree to which terms associated with the set of candidate digital ads overlap with terms in the first search query, weighted based on a number of times a term appears in both the set of candidate digital ads and the first search query;
determining a degree of relevance between the set of candidate digital ads and the first search query based on the co-occurrence of a first term and a second term, which is different from the first term but is related to the first term, in the set of candidate digital ads and the first search query;
determining a quality of the set of candidate digital ads based on a bid price associated with two or more digital ads of the set of candidate digital ads;
determining a quality of the set of candidate digital ads based on a coefficient of variation of an ad score associated with two or more digital ads of the set of candidate digital ads; and
determining a quality of the set of candidate digital ads based on a degree of topical cohesiveness of two or more digital ads of the set of candidate digital ads.

16. A system for predicting a degree of relevance between a set of candidate digital ads and a search query, the system comprising:
an ad provider operative to identify a set of candidate digital ads comprising at least one digital ad that may be served in response to a digital ad request; and
a relevance module in communication with the ad provider, the relevance module operative to:
extract a set of features from the set of candidate digital ads and a first search query that is associated with the digital ad request; and
determine a degree of relevance between the set of candidate digital ads and the first search query based on a prediction module and the set of features extracted from the set of candidate digital ads and the first search query;
wherein the ad provider is further operative to determine whether to serve at least one digital ad of the set of candidate digital ads based on the determined degree of relevance between the set of candidate digital ads and the first search query.

17. The system of claim 17, wherein the relevance module is further operative to:
receive an indication of a degree of relevance between a plurality of digital ads and a second search query from a user;
extract a set of features from the plurality of digital ads and the second search query; and
build the prediction model to predict a degree of relevance between a set of candidate digital ads and a search query based on at least the received indication of relevance and the set of features extracted from the plurality of digital ads and the second search query.

18. The system of claim 16, wherein to extract the set of features from the set of candidate digital ads and the first search query, the relevance module is operative to perform at least one of:
determine a degree to which terms associated with the set of candidate digital ads overlap with terms in the first search query;
determine a degree to which terms associated with the set of candidate digital ads overlap with terms in the first search query, weighted based on a number of times a term appears in both the set of candidate digital ads and the first search query;
determine a degree of relevance between the set of candidate digital ads and the first search query based on the co-occurrence of a first term and a second term, which is different from the first term but is related to the first term, in the set of candidate digital ads and the first search query;
determine a quality of the set of candidate digital ads based on a bid price associated with two or more digital ads of the set of candidate digital ads;
determine a quality of the set of candidate digital ads based on a coefficient of variation of an ad score associated with two or more digital ads of the set of candidate digital ads; and
determine a quality of the set of candidate digital ads based on a degree of topical cohesiveness of two or more digital ads of the set of candidate digital ads.
